(19) United States
(12) Patent Application Publication
(10) Pub. No.: US 2010/0026115 A1
(43) Pub. Date: Feb. 4, 2010

(54) STATOR WINDINGS AND AN ELECTRIC ROTARY MACHINE

(75) Inventors: Hirofumi KINJOU, Oobu-shi (JP); Sadahisa Onimaru, Chiryu-shi (JP)

Correspondence Address: NIXON & VANDERHYE, PC, 901 NORTH GLEBE ROAD, 11TH FLOOR, ARLINGTON, VA, 22203, US

(73) Assignee: NIPPON SOKEN, INC., Nishio-city (JP)

(21) Appl. No.: 12/533,384

(22) Filed: Jul. 31, 2009

(30) Foreign Application Priority Data
Aug. 1, 2008 (JP) 2008-200097

(51) Int. Cl. H02K 11/00

(52) U.S. Cl. 310/71

(57) ABSTRACT

Stator windings for an electric rotary machine comprise a lead wire wound in predetermined form that has a lead part formed by laminating plate-like conductors, a beginning and an end of a winding of the lead part are connected to the conductors, and at least one place between a beginning and an end of a winding of the lead part is twisted.

### CROSS-REFERENCE TO RELATED APPLICATION

This application is based on and claims the benefit of priority from earlier Japanese Patent Application No. 2008-200097 filed Aug. 1, 2008, the contents of which are incorporated herein by reference.

### BACKGROUND OF THE INVENTION

1. Technical Field of the Invention

The present invention relates to stator windings of an electric rotary machine, and the electric rotary machine itself.

2. Description of the Related Art

There is disclosed an electric rotary machine used as an electric motor and a dynamo in Japanese Patent Application Laid-Open Publication No. 2005-160143, for example.

In the above-mentioned Publication No. 2005-160143, there is disclosed an electric rotary machine having stator windings that includes laminated flat conductors that are formed by flat conductors with a predetermined shape and number of lamination. The predetermined shape has an open end part that is opened windably to a stator iron core. The laminated flat conductors are inserted into slots provided on the stator iron core. The open end parts of the laminated flat conductors are then bridged to form the stator windings.

The above-mentioned electric rotary machine has an effect of reducing an eddy current loss generated by leaking magnetic flux that interlinks to leading wires of the stator windings by inserting the laminated flat conductors having the open end parts into the slots of the iron core and bridge the end parts for each winding.

Dividing the conductor in the direction that divides the eddy current reduces the eddy current loss resulting from the leaking magnetic flux.

However, if the laminated flat conductors are joined at the open ends, the laminated flat conductors are mutually connected in parallel electrically and current flows. Therefore, a route that the eddy current newly flows is formed via a junction part when magnetic flux interlinks, thus the problem arises that the eddy current loss reduction effect decreases.

### SUMMARY OF THE INVENTION

The present invention has been made in light of the problem explained above, and has as its object to provide stator windings of an electric rotary machine that reduces an eddy current loss that occurs in leading wires from interlinking of magnetic flux.

In order to solve the above-mentioned subject, the inventor and the others came to make the present invention, as a result of repeated research on stator windings.

In the stator windings of the electric rotary machine according to a first aspect, the stator windings for the electric rotary machine comprise a lead wire wound in predetermined form that has a lead part formed by laminating plate-like conductors, wherein, a beginning and an end of a winding of the lead part are connected to the conductors, at least one place is twisted between a beginning and an end of a corresponding winding.

In the above-mentioned stator windings, the stator has at least one place of a corresponding winding twisted, and the direction of the eddy currents generated in the laminated conductor is reversed by the twist so that the eddy currents are canceled. Consequently, generation of the eddy current loss is suppressed in the stator windings of the present invention.

In the stator windings of the electric rotary machine according to a second aspect, the lead part is twisted at a position where the induced electromotive force is reduced by half of the original electromotive force.

In the stator windings of the electric rotary machine according to a third aspect, the lead part forms the entire part of the lead wire.

In the stator windings of the electric rotary machine according to a fourth aspect, the lead part forms at least a part of the lead wire.

In the stator windings of the electric rotary machine according to a fifth aspect, the conductors of the lead part spread along the direction of the magnetic flux flow.

In the stator windings of the electric rotary machine according to a sixth aspect, the stator has a rotor formed inside the stator, and the rotor having magnetic poles that alternate in a circumferential direction.

### BRIEF DESCRIPTION OF THE DRAWINGS

In the accompanying drawings:

FIG. 1 shows a sectional view of an electric rotary machine of a first embodiment;

FIG. 2 shows a composition of stator windings of the electric rotary machine of the first embodiment;

FIG. 3 shows another composition of stator windings of the electric rotary machine of the first embodiment;

FIG. 4 shows another composition of stator windings of the electric rotary machine of the first embodiment;

FIG. 5 shows another composition of stator windings of the electric rotary machine of the first embodiment;

FIG. 6 shows a composition of stator windings of the electric rotary machine of a second embodiment;

FIG. 7 shows another composition of stator windings of the electric rotary machine of the second embodiment;

FIG. 8 shows a composition of stator windings of the electric rotary machine of a third embodiment;

FIG. 9 shows a composition of stator windings of the electric rotary machine of a fourth embodiment; and

FIG. 10 shows a composition of stator windings of the electric rotary machine of a fifth embodiment.

### DETAILED DESCRIPTION OF THE PREFERRED EMBODIMENTS

With reference to the accompanying drawings, hereinafter are described embodiments of the present invention.

### The First Embodiment

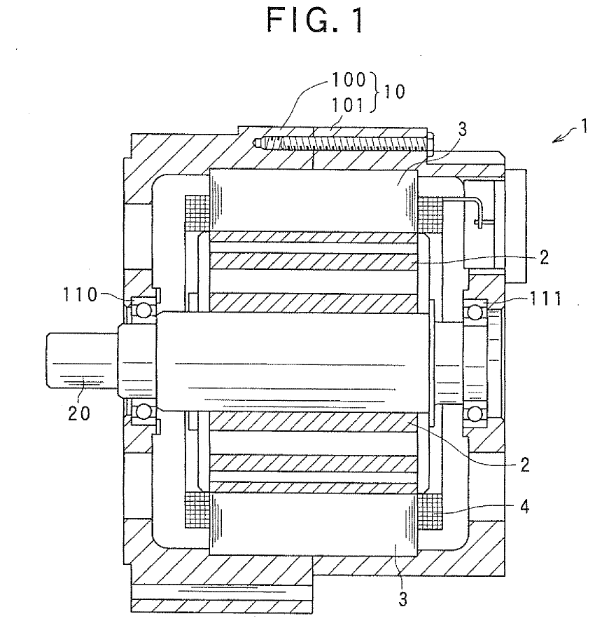

As shown in FIG. 1, an electric rotary machine 1 regarding the present invention comprises a housing 10, a rotor 2, and a stator 3. The housing 10 is constituted of a pair of housing members 100 and 101. Each of the housing members 100 and 101 has a tubular shape with one end closed. Openings of the housing members 100 and 101 are joined together to form the housing 10. A rotating shaft 20 is provided inside the housing 10 via bearings 110 and 111, and the rotor 2 is fixed to the rotating shaft 20. The stator 3 is fixed to the housing 10 in the position that surrounds the rotor 2 inside the housing 10.

The rotor 2 forms a plurality of magnetic poles on its perimeter that face each other to an inner circumference of the stator 3. The magnetic poles alternate in the circumferential direction in turns and are composed by permanent magnets.

By the way, the number of the magnetic poles of the rotor 2 is not limited because every electric rotary machine differs.

The stator 3 is provided with a stator core 30 and the stator windings 4 that are wound around the stator core 30.

The stator core 30 has a ring shape and a plurality of slots 31 is formed on its inner circumference.

Teeth parts 32 that are projected in a radial direction divide the slots 31, and they are formed so that the depth direction matches with the radial direction.

Laminating electromagnetic steel plates in their thickness direction forms the stator core 30. Insulating thin films (not shown) are arranged between the laminated electromagnetic steel plates.

It should be appreciated that the stator core 30 is not only formed by the laminated electromagnetic steel plates but may be formed by conventionally well-known thin metal plates with insulating thin films.

The stator windings 4 have the composition that a lead wire 40 is wound by a predetermined winding method.

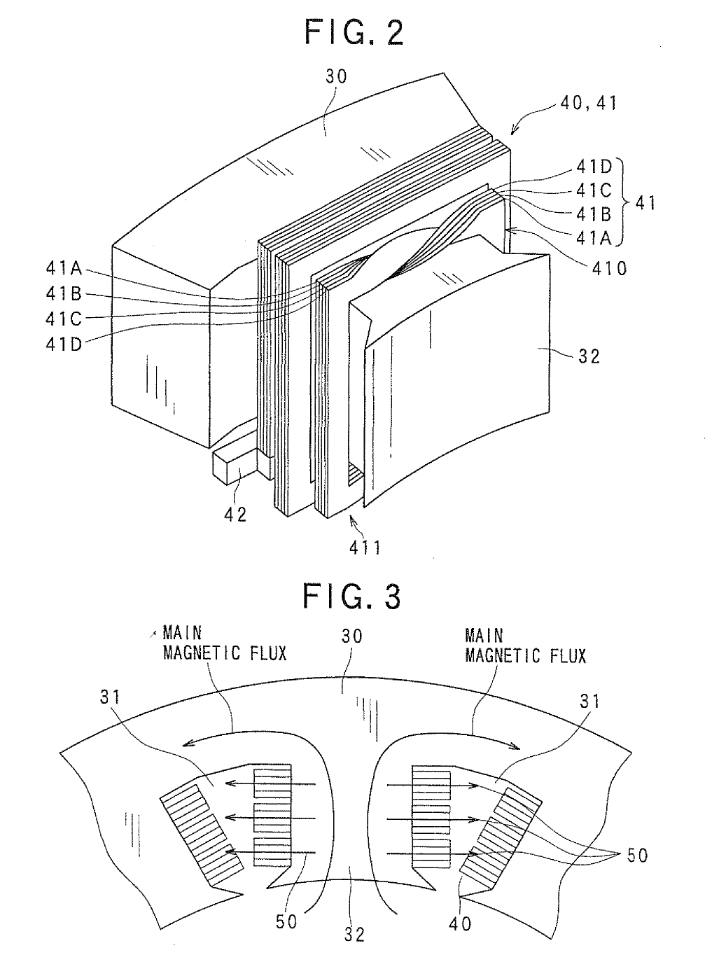

As shown in FIG. 2, the lead wire 40 that constitutes stator windings 4 has a lead part 41 that laminates thin plate-like conductors 41A-41D in their thickness direction, and a regular lead wire 42 that the both ends of the lead part 41 are joined but not laminated.

Winding the lead part 41 to the teeth part 32 for a plurality of times continuously forms the stator windings 4.

At this time, the lead wire 40 is wound in the state where the direction of the conductors 41A-41D being laminated matches the radial direction of the stator windings 4.

In the FIG. 2 showing the present embodiment, the lead part 41 is wound in the state where the teeth part 32 is overlapped doubly.

A beginning and an end of the winding of the lead part 41 (end parts) are connected to the regular lead wire 42

The regular lead wire 42 is connected to either the beginning or the end of the lead part 41 that is wound to the adjoining teeth part 32 to form the stator windings 4.

In the stator windings 4, the lead part 41 is wound twice around the teeth part 32 continuously.

In detail, a first round of the winding part 410 is formed when winding is finished on the perimeter of the teeth part 32 by winding the lead part 41 to the teeth part 32 from the outside of the teeth part 32 in the radial direction towards the inside in the radial direction.

At the end part of the winding part 410 (the end part inside of the teeth part 32 in the radial direction) of the first round, the lead part 41 is twisted 180 degrees.

That is, the laminating direction of the conductors 41A-41D is reversed on both sides of a twist.

Moreover, the lead part 41 is wound around the perimeter of the first round of the winding part 410 from inside of the teeth part 32 in the radial direction toward the outside in the radial direction.

In the present embodiment, there is provided a twist in the central part between the beginning and the end of the winding, i.e. the position where the induced electromotive force becomes ½.

In the stator windings 4, the row of conductors 41A-41D is reversed against the leaking magnetic flux at the first round of the winding part 410 and the second round of the winding part 411.

Specifically, at the first round of the winding part 410, the thin plate conductors 41A-41D are laminated in this order from inside of the teeth part 32 in the radial direction toward the outside in the radial direction. On the other hand at the second round of the winding part 411, the thin plate conductors 41D-41A are laminated in this order from inside of the teeth part 32 in the radial direction toward the outside in the radial direction.

When the electric rotary machine 1 of the present embodiment is driven, the main magnetic flux flow inside of the stator core 30 is as arrows shown in FIGS. 3 and 4, and leaking magnetic flux 50 occurs.

This leaking magnetic flux 50 is generated in the direction interlinking to the first round of the winding part 410 and the second round of the winding part 411 of the lead part 41.

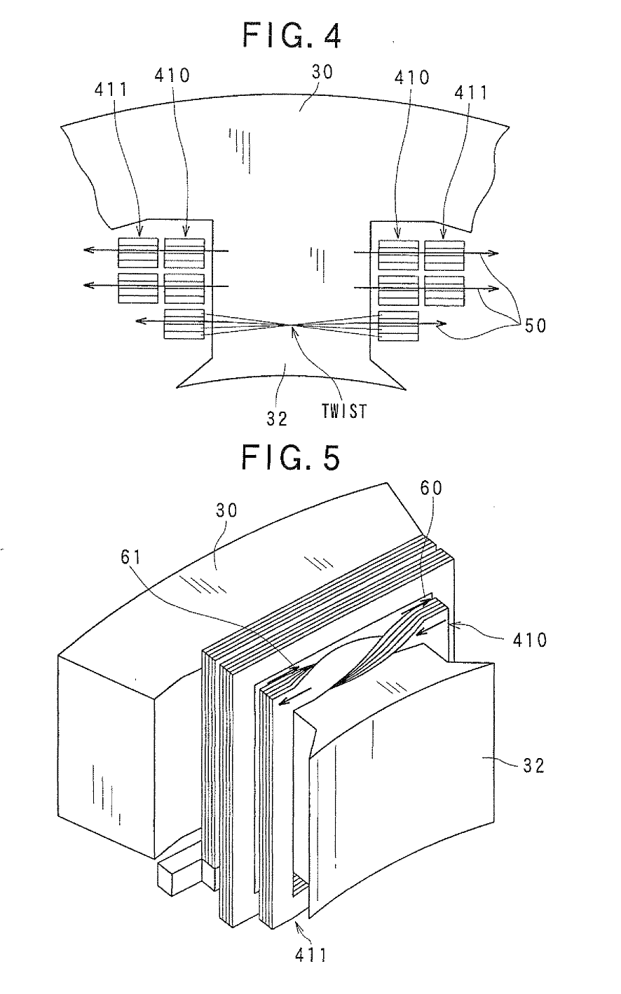

In addition, as shown in FIG. 5, generated leaking magnetic flux 50 acts so that an eddy current 60 flows in the first round of the winding part 410 and an eddy current 61 flows in the second round of the winding part 411.

In the present embodiment, since the row of conductors 41A-41D is reversed by the twist, the first round of the winding part 410 and the second round of the winding part 411 are reversed.

Thereby, the eddy currents 60 and 61 are canceled between two winding parts 410 and 411. Consequently, generation of the eddy current loss in the stator windings 4 is suppressed, thus the electric rotary machine 1 of the present embodiment suppresses loss of the energy generated by the eddy current.

In addition, in the electric rotary machine 1 and the stator windings 4 of the present embodiment, the regular lead wire 42 is connected only to the beginning and the end of the winding of the teeth part 32. Further, the electric rotary machine 1 and the stator windings 4 of the present embodiment has the effect that prevents the generation of the eddy current loss without increasing the number of connecting parts compared with a structure of the stator windings that inserts windings to each and every teeth part formed.

### The Second Embodiment

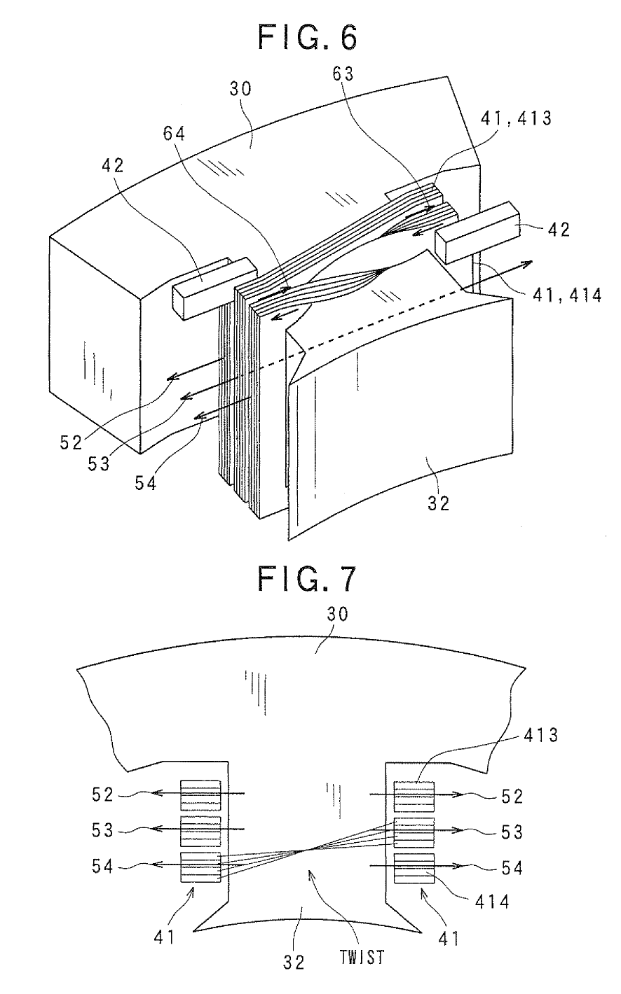

The present embodiment is an electric rotary machine of the same composition as the first embodiment, except that the forms of stator windings differ. The stator windings 4 of the present embodiment are shown in FIGS. 6 and 7, It should be appreciated that the same reference numbers are given to the same elements as the first embodiment, and explanation of these identical parts is omitted.

Winding the single round of the lead part 41 around the perimeter of the teeth part 32 forms the stator windings 4 of the present embodiment. The lead part 41 is formed by laminating the thin plate-like conductors 41A-41D, which are similar to those of the first embodiment, in their thickness direction.

Specifically, the lead part 41 is wound around the teeth part 32 from the end of the beginning of the winding at the outermost position of the teeth part 32 in the radial direction towards the inside in the radial direction, and the lead part 41 is twisted 180 degrees in the middle.

Moreover, the last end of the winding of the winding part 41 is positioned at the end side of the teeth part 32 inside in the radial direction. The beginning and the end of the winding are connected to the regular lead wire 42.

In the present embodiment, the eddy current is canceled between the outside lead part 413 located outside of the teeth part 32 in the radial direction of the twist and the inside lead part 414 located inside in the radial direction.

Specifically, the leaking magnetic flux is distributed in the radial direction, and when sizes of the leaking magnetic flux 52-54, which interlinks the winding part 41 as shown in FIG. 7, are set to φ, 2φ and 3φ from the outside of the teeth part 32 in the radial direction toward the inside in the radial direction, respectively, the sum of the induced electromotive force that acts on the outside lead part 413 is proportional to the size of the leaking magnetic flux (φ+2φ), and the induced electromotive force that acts on the inside lead part 414 is proportional to the size of the leaking magnetic flux (3φ).

Therefore, since the eddy currents 63 and 64 generated in each of the outside lead part 413 and the inside lead part 414 become the same size but reversed in phase by putting the twist into the winding part 41, the eddy currents 63 and 64 can be canceled between the outside lead part 413 and the inside lead part 414.

Thereby, generation of the eddy current loss can be prevented. That is, also in the present embodiment, the same effect as the first embodiment can be demonstrated.

### The Third Embodiment

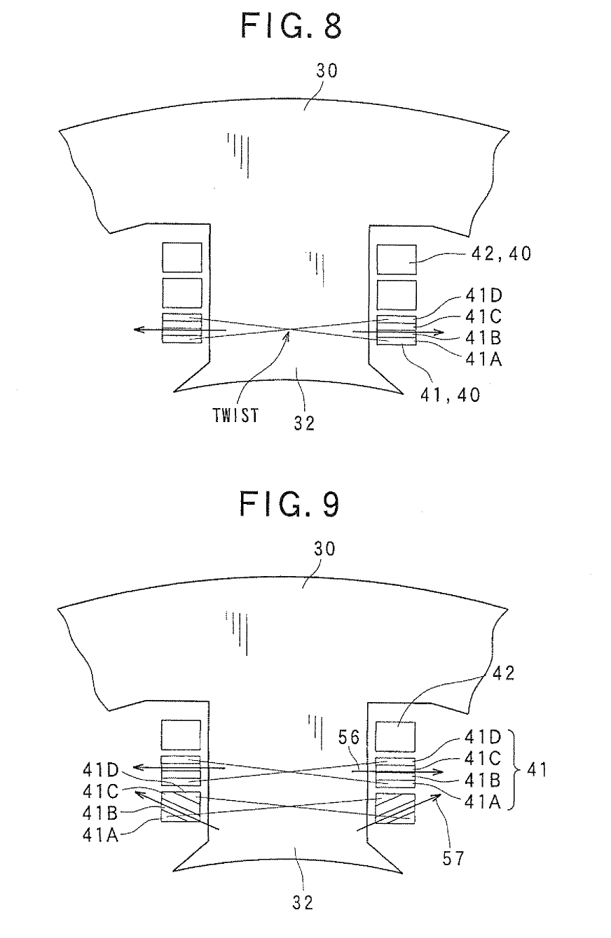

The present embodiment is an electric rotary machine of the same composition as the second embodiment, except that the forms of stator windings differ. The outline composition figure of the stator windings 4 of the present embodiment are shown in FIG. 8. It should be appreciated that the same reference numbers are given to the same elements as the second embodiment, and explanation of these identical parts is omitted.

The lead part 41 is formed by laminating the thin plate-like conductors 41A-41D, which are similar to those of the first embodiment, in their thickness direction. The lead part 41 constitutes a part of the lead wire 40 in the stator windings 4 of the present embodiment.

In the present embodiment, the lead part 41 is formed inside of the teeth part 32 in the radial direction where the leaking magnetic flux is large.

The twist is formed in the lead part 41. The leads 40 other than lead part 41 are formed with the regular lead wire 42.

The same effect as the first and the second embodiments can be demonstrated in the present embodiment.

### The Fourth Embodiment

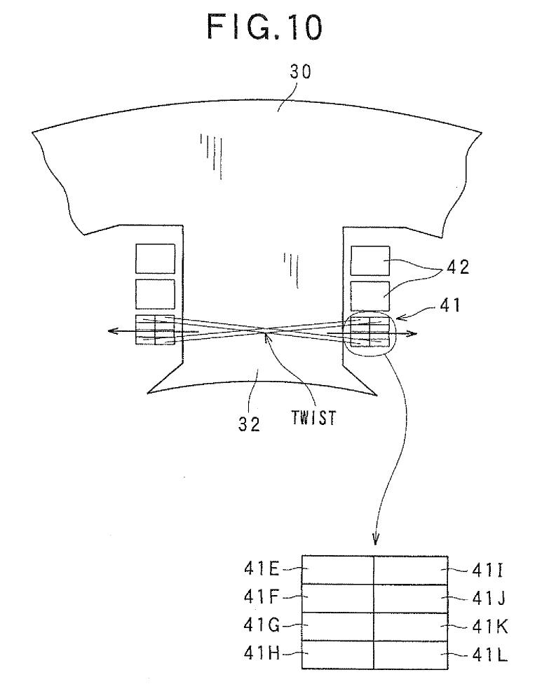

The present embodiment is an electric rotary machine of the same composition as the third embodiment, except that the forms of stator windings differ. The outline composition figure of the stator windings 4 of the present embodiment are shown in FIG. 9. It should be appreciated that the same reference numbers are given to the same elements as the third embodiment, and explanation of these identical parts is omitted.

The lead part 41 is formed by laminating the thin plate-like conductors 41A-41D, which are similar to those of the first embodiment, in their thickness direction. The lead part 41 constitutes a part of the lead wire 40 in the stator windings 4 of the present embodiment.

In the present embodiment, the lead part 41 is formed inside of the teeth part 32 in the radial direction where the leaking magnetic flux is large.

The twist is formed in the lead part 41. The leads 40 other than lead part 41 are formed with the regular lead wire 42.

Further, as for the lead part 41, the direction where the conductors 41A-41D spread is so formed in the direction in which the leaking magnetic flux 56 and 57 is extended.

Thus, the loss reduction effect can be heightened by arranging the conductors 41A-41D as mentioned above, and by dividing each lead part 41 by the twist according to the direction of the magnetic flux 56 and 57 that divides the eddy current.

The same effect as the first—the third embodiments can be demonstrated in the present embodiment.

### The Fifth Embodiment

The present embodiment is an electric rotary machine of the same composition as the third embodiment, except that the composition of the conductor that constitutes the lead part 41 of the stator windings differs. The outline composition figure of the stator windings 4 of the present embodiment is shown in FIG. 10. It should be appreciated that the same reference numbers are given to the same elements as the third embodiment, and explanation of these identical parts is omitted.

Although laminating the thin plate-like conductors 41A-41D in their thickness direction forms the lead part 41 of the above-mentioned first-fourth embodiments, the thin plate-like conductors 41E-41L are laminated in their thickness and width directions in the present embodiment.

The same effect as the first—the fourth embodiments can be demonstrated in the present embodiment.

In the present embodiment, the flexibility of the lead part 41 is improved and it becomes easy to form the stator windings 4 and the electric rotary.

What is claimed is:

1. Stator windings for an electric rotary machine comprising:
a lead wire wound in predetermined form that has a lead part formed by laminating plate-like conductors;
wherein, a beginning and an end of a winding of the lead part are connected to the conductors; and
at least one place is twisted between a beginning and an end of a corresponding winding.

2. The stator windings according to claim 1, wherein, the lead part is twisted at a position where the induced electromotive force is reduced by half of the original electromotive force.

3. The stator windings according to claim 1, wherein, the lead part forms the entire part of the lead wire.

4. The stator windings according to claim 1, wherein, the lead part forms at least a part of the lead wire.

5. The stator windings according to claim 1, wherein, the conductors of the lead part spread along the direction of the magnetic flux flow.

6. The electric rotary machine according to claim 1, wherein, the stator has a rotor formed inside the stator, and
the rotor having magnetic poles that alternate in a circumferential direction.

7. The electric rotary machine according to claim 2, wherein, the stator has a rotor formed inside the stator, and
the rotor having magnetic poles that alternate in a circumferential direction.

8. The electric rotary machine according to claim 3, wherein, the stator has a rotor formed inside the stator, and
the rotor having magnetic poles that alternate in a circumferential direction.

9. The electric rotary machine according to claim 4, wherein, the stator has a rotor formed inside the stator, and
the rotor having magnetic poles that alternate in a circumferential direction.

10. The electric rotary machine according to claim 5, wherein, the stator has a rotor formed inside the stator, and
the rotor having magnetic poles that alternate in a circumferential direction.
